(19) United States
(12) Patent Application Publication
(10) Pub. No.: US 2021/0111918 A1
(43) Pub. Date: Apr. 15, 2021

(54) REMOTE SERVICE DIAGNOSTICS AND SERVICE SCHEDULING FOR APPLIANCES

(71) Applicant: Haier US Appliance Solutions, Inc., Wilmington, DE (US)

(72) Inventors: Je Kwon Yoon, Hwaseong (KR); Kyoung-June Yi, Namyangju (KR); Junga Lee, Yongin (KR); JaeHyo Lee, Seoul (KR); Sangrok Lee, Seocho-gu (KR); Hyoyeol Maeng, Buecheon (KR)

(21) Appl. No.: 16/599,373

(22) Filed: Oct. 11, 2019

(51) Int. Cl. H04L 12/28; G06Q 10/10; G06Q 10/06; G05B 23/02; G06F 3/0488

(52) U.S. Cl. CPC H04L 12/2825; H04L 12/2814; G06Q 10/109; G06F 3/0488; G05B 23/0272; G05B 23/0283; G06Q 10/06311

(57) ABSTRACT

A method of automating the diagnostics and scheduling of service calls associated with a malfunctioning appliance is provided. The method includes obtaining data associated with a trigger event based on a fault code of a malfunctioning appliance, identifying one or more technicians based on the obtained data, determining the availability of the one or more technicians, providing the availability of the identified one or more technicians for display on a user interface of an interactive assembly in communication with the malfunctioning appliance, and receiving a user selection of a technician through user interaction with the user interface on the interactive assembly.

### FIELD OF THE INVENTION

The present subject matter relates generally to systems for automating diagnostics and repair of appliances, and more particularly to systems for automating the scheduling of service calls and diagnostics of appliances.

### BACKGROUND OF THE INVENTION

Appliances generally include some diagnostic functionality. The diagnostic functionality may be accessed via a dedicated access interface, such as a universal serial bus (USB), wireless interface (e.g., Bluetooth or WiFi), or network interface. The dedicated access interface may be connected to a computer or laptop by a technician to determine any diagnostic issues. Furthermore, a dedicated access interface for each appliance in a home must be accessed individually. Thereafter, the technician may determine warranty status, order any necessary parts, service the appliance, or repair the appliance.

Unfortunately, these existing systems require a user to first determine that an appliance is malfunctioning. Subsequently, the user may be required to communicate with a service center, provide appliance identifying information via telephone or Internet, and then arrange for a service call. This process may be lengthy, cumbersome, and detract from a user's engagement experience. Furthermore, this process may be prone to errors if a user misreads an appliance label, provides incorrect appliance identifying information, or otherwise makes an error.

As a result, improved systems are needed for facilitating service diagnostics and service call scheduling. In particular, it may be advantageous to provide a system to permit automatic scheduling of service calls and diagnostics of appliances.

### BRIEF DESCRIPTION OF THE INVENTION

Aspects and advantages of the invention will be set forth in part in the following description, or may be obvious from the description, or may be learned through practice of the invention.

In one example aspect of the present disclosure, a method of automating the diagnostics and scheduling of service calls associated with a malfunctioning appliance is provided. The method includes obtaining data associated with a trigger event based on a fault code of a malfunctioning appliance, identifying one or more technicians based on the obtained data, determining the availability of the one or more technicians, providing the availability of the identified one or more technicians for display on a user interface of an interactive assembly in communication with the malfunctioning appliance, and receiving a user selection of a technician through user interaction with the user interface on the interactive assembly.

In another example aspect of the present disclosure, a system is provided. The system includes an interactive assembly having a casing, an image monitor supported by the casing, and a controller communicatively coupled with the image monitor. The controller is configured to obtain data associated with a trigger event based on a fault code of a malfunctioning appliance, identify one or more technicians based on the obtained data, determine the availability of the one or more technicians, provide the availability of the identified one or more technicians for display on a user interface of an interactive assembly in communication with the malfunctioning appliance, and receive a user selection of a technician through user interaction with the user interface on the interactive assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front perspective view of an appliance with an interactive assembly according to example embodiments of the present disclosure;

FIG. 2 provides a perspective view of an interactive assembly of an appliance according to example embodiments of the present disclosure;

FIG. 3 provides a schematic diagram of a system of automating the scheduling of service calls and diagnostics of appliances, according to example embodiments of the present disclosure;

FIG. 4 is a diagram of an appliance diagnostic user interface, according to example embodiments of the present disclosure;

FIG. 5 is a diagram of a service scheduling user interface, according to example embodiments of the present disclosure;

FIG. 6 is a diagram of a service scheduling user interface, according to example embodiments of the present disclosure;

FIG. 7 is a diagram of a service interactive user interface, according to example embodiments of the present disclosure;

FIG. 8 is a flowchart of a method of automating the diagnostics of appliances, according to example embodiments of the present disclosure; and

FIG. 9 is a flowchart of a method of automating the scheduling of service calls of appliances, according to example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present disclosure. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

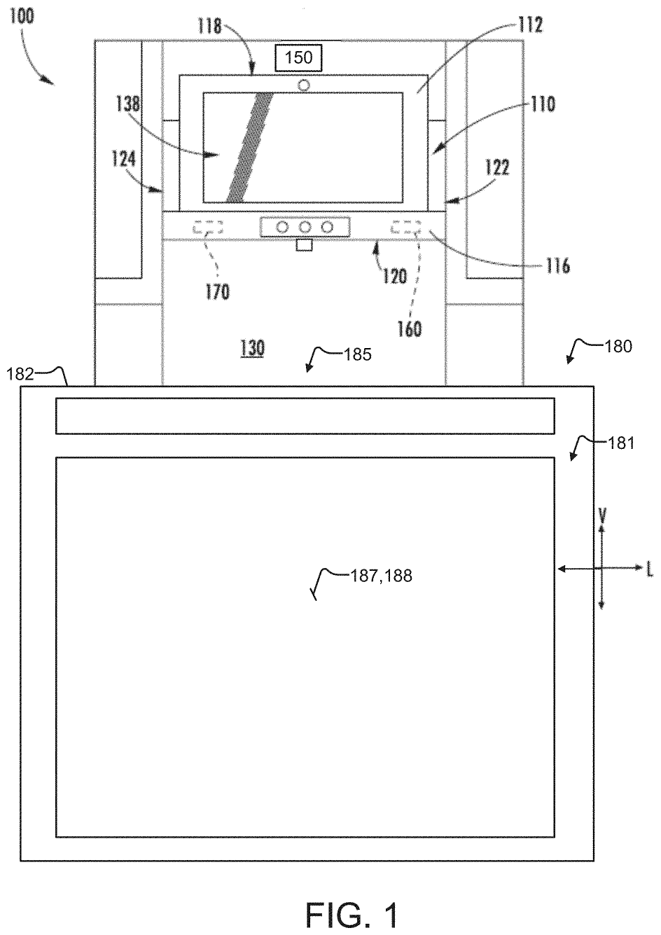

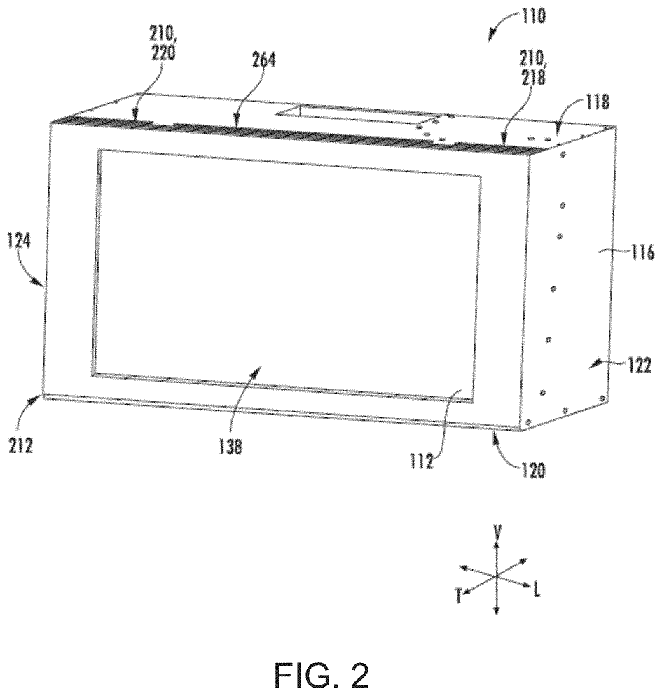

FIGS. 1 and 2 provide various views of an appliance 100 according to example embodiments of the present disclosure. Generally, appliance 100 includes a cooktop appliance 180 and an interactive assembly 110 positioned above cooktop appliance 180 as shown in FIGS. 1 and 2. The features of cooktop appliance 180 and interactive assembly 110 are provided below.

As shown in FIGS. 1 and 2, cooktop appliance 180 defines a vertical direction V, a lateral direction L (FIG. 1), and a transverse direction T (FIG. 2). The vertical, lateral, and transverse directions V, L, T are mutually perpendicular and form an orthogonal direction system. Cooktop appliance 180 extends beneath the interactive assembly 110 along the vertical direction V.

Cooktop appliance 180 includes a chassis or cabinet 181 and a cooktop surface 182 having one or more heating elements 185 for use in, for example, heating or cooking operations. In some embodiments, cooktop surface 182 is constructed with ceramic glass. In other embodiments, however, cooktop surface 182 may be formed of another suitable material, such as a metallic material (e.g., steel) or another suitable non-metallic material. Heating elements 185 may be various sizes and may employ any suitable method for heating or cooking an object, such as a cooking utensil (not shown), and its contents. In addition, cabinet 181 is insulated and defines a cooking chamber 187 selectively covered by a door 188. One or more chamber heating elements (e.g., top broiling elements or bottom baking elements) may be enclosed within cabinet 181 to heat cooking chamber 187.

Although particularly illustrated as being an oven, it should be understood that the appliance 180 may be any suitable appliance, including a dishwasher, washing machine, clothes dryer, or any suitable appliance. Furthermore, in some embodiments, the interactive assembly may be a standalone central assembly not directly associated with a single appliance (e.g., FIG. 2).

As shown further in FIGS. 1 and 2, interactive assembly 110 includes one or more casings positioned above cooktop appliance 180 along the vertical direction V. For this embodiment, interactive assembly 110 includes a casing 116 positioned above cooktop appliance 180. Casing 116 includes a plurality of outer walls and generally extends between a top end 118 and a bottom end 120, e.g., along the vertical direction V; between a first side end 122 and a second side end 124 (FIG. 1), e.g., along the lateral direction L; and between a front end 126 and a rear end 128 (FIG. 2), e.g., along the transverse direction T. In some embodiments, casing 116 is spaced from cooktop surface 324 along the vertical direction V. An open region 130 may thus be defined along the vertical direction V between cooktop surface 182 and bottom end 120 of casing 116.

In some embodiments, casing 116 is formed as a range hood. However, a range hood is provided by way of example only. Other configurations may be used within the spirit and scope of the present disclosure. For example, casing 116 could be part of a microwave or other appliance designed to be located above cooktop surface 182. Moreover, although a generally rectangular shape is illustrated, any suitable shape or style may be adapted to form the structure of casing 116.

As further depicted in FIGS. 1 and 2, the interactive assembly 110 includes a controller 150 and an image monitor 112 communicatively coupled thereto. The image monitor 112 is mounted to and supported by casing 116. Image monitor 112 is provided above cooktop surface 182, e.g., along the vertical direction V. More particularly, for this embodiment, image monitor 112 is mounted to and supported on casing 116 (e.g., directly above cooktop surface 182) proximate to the front end 126 of casing 116. Generally, image monitor 112 may be any suitable type of mechanism for visually presenting an image (e.g., a digital image). For example, image monitor 112 may be a liquid crystal display (LCD), a plasma display panel (PDP), a cathode ray tube (CRT) display, etc. Image monitor 112 includes an imaging surface 138 (e.g., screen or display panel) at which the image is presented or displayed as an optically-viewable picture (e.g., static image or dynamic video) to a user. Optionally, a protective transparent panel (e.g., formed from a transparent glass, plastic, etc.) may be positioned across or over imaging surface 138. In such embodiments, the protective transparent panel is mounted within or supported on casing 116 forward of imaging surface 138 along the transverse direction T. In some example embodiments, the image monitor 112 has touchscreen capability. Accordingly, the image monitor 112 may be a relatively large, touchscreen display. In this way, a user may touch various digitally presented images to control various features, such as e.g., the images displayed by image monitor 112, appliances communicatively coupled with controller 150, and other features, such as e.g., a camera, a microphone, etc.

The optically-viewable image at the imaging surface 138 of image monitor 112 may correspond to any suitable signal or data received or stored by interactive assembly 110 (e.g., at controller 150). As an example, image monitor 112 may present recipe information in the form of viewable text or images. As another example, image monitor 112 may present a remotely captured image, such as a live (e.g., real-time) dynamic video stream received from a separate user or device. As yet another example, image monitor 112 may present a graphical user interface (GUI) that allows a user to select or manipulate various operational features of interactive assembly 110, cooktop appliance 180, or other components communicatively coupled with controller 150, e.g., via image monitor's touchscreen capabilities described above. During use of such GUI embodiments, a user may engage, select, or adjust the image presented at image monitor 112 through any suitable input, such as gesture controls detected through a camera assembly, voice controls detected through one or more microphones, associated touch panels (e.g., capacitance or resistance touch panel) or sensors overlaid across imaging surface 138, etc.

Additionally, and as described in more detail below, the controller 150 may facilitate the interaction, communication, and collection of diagnostic information from a plurality of appliances. The controller 150 may further facilitate the automatic scheduling of service calls based on the collected diagnostic information through various user interfaces displayed on the image monitor 112.

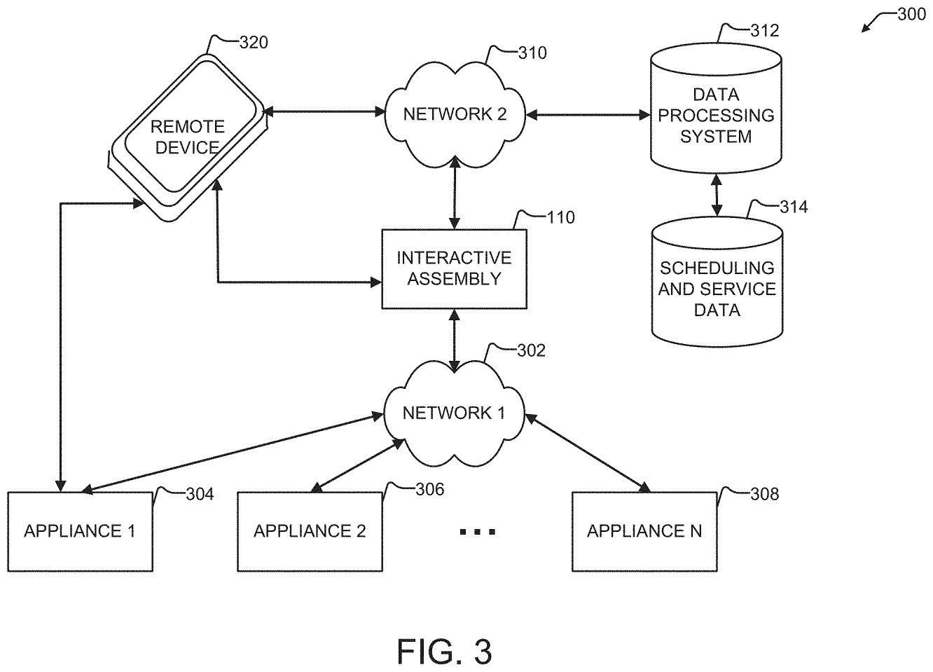

FIG. 3 provides a schematic diagram of a system 300 of automating the scheduling of service calls and diagnostics of appliances, according to example embodiments of the present disclosure. As shown, the system 300 includes the interactive assembly 110 in operative communication with a first network, such as a home network, 302. The first network 302 may include any suitable network, including wireless or wired networks having one or more routing devices, hubs, switches, or other communication components not illustrated. The first network 302 may connect to the interactive assembly 302 and facilitate communication of diagnostic data from a plurality of appliances 304, 306, and 308. Any number of appliances may be connected to the first network 302. Generally, each of the appliances 304, 306, and 308 may include associated computer processors configured to execute instructions associated with facilitating requests for diagnostic data. The diagnostic data may include fault codes, operational statistics, usage data, serial number or other identification data, and any other suitable data. Fault codes and other diagnostic data may provide for specific information which aids in supplying repair expectations and/or spare parts on an initial service visit. This may reduce the number of potentially necessary service calls and visits, and potentially offer cost savings as well as other benefits.

As further illustrated, the system 300 further includes a second network 310 in operative communication with the interactive assembly 110. The second network may be, for example, the Internet. Using the second network 310, the interactive assembly may transmit diagnostic data associated with one or more of the appliances 304, 306, and 308 to a data processing system 312 located remotely from the interactive assembly 110.

The data processing system 312 may be associated, for example, with an appliance manufacturer or appliance service call center. Furthermore, the data processing system may be in operative communication with a scheduling and service data store 314. The scheduling and service data store 314 may be configured to store scheduling information for any number of technicians equipped to service the appliances 304, 306, and 308. The technicians may either communicate directly with the data processing system 312 at a call center, or may connect remotely with a remote device 320.

Generally, the remote device 320 may include a cellphone, tablet, mobile computer, or other remote computing device configured to transmit and receive scheduling and service request information over the network 310. The remote device 320 may also be configured to communicate directly with the interactive assembly 110 to receive diagnostic data for the appliances 304, 306, and 308. Still further, the remote device 320 may also be configured to communicate directly with the appliances 304, 306, and 308 via any available dedicated diagnostic communication interface.

As described briefly above, the interactive assembly 110 may be configured to display a plurality of different user interfaces. The plurality of user interfaces may facilitate the automatic collection, aggregation, and transmission of diagnostic data associated with the appliances 304, 306, and 308. Furthermore, the plurality of user interfaces may facilitate the automatic scheduling of service calls using the diagnostic data. Moreover, the plurality of user interfaces may facilitate communication with the data processing system 312, the associated call center, and/or the remote device 320 via interactive chat functions and other functions. Hereinafter, user interfaces and associated methodology for automated diagnostics and scheduling of service calls is described in detail.

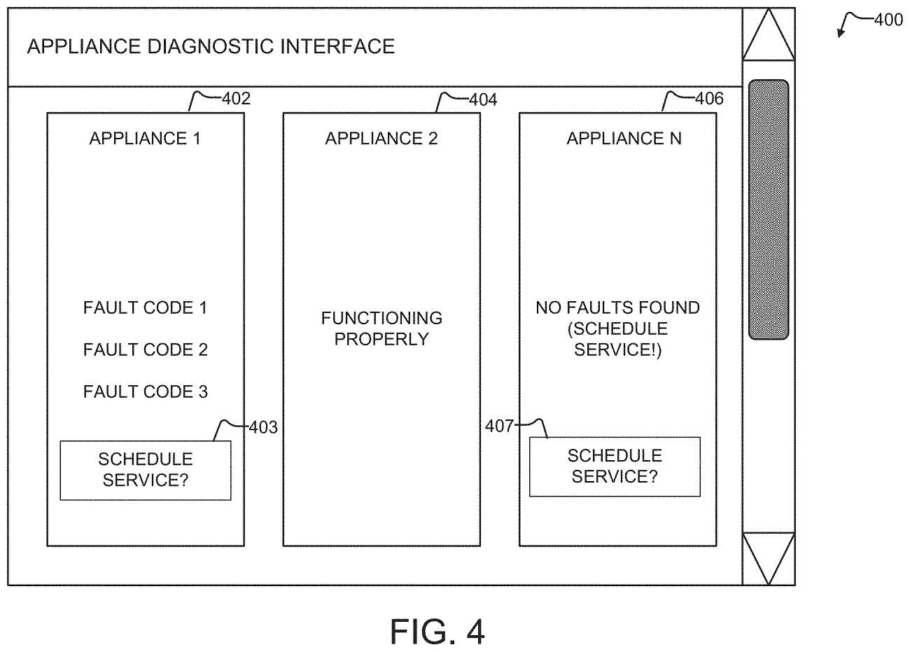

FIG. 4 is a diagram of an appliance diagnostic user interface 400, according to example embodiments of the present disclosure. The user interface 400 can include a plurality of individual appliance diagnostic sections, 402, 404, and 406. Each of the individual appliance diagnostic sections 402, 404, and 406 are associated with a single appliance, such as a cooktop, refrigerator, or microwave. As shown, Appliance 1 in this example is showing three consecutive fault codes associated with operation of appliance 1. Accordingly, a user may select the section 402 using a touchscreen interface element 403 and initiate a service request.

As also shown, appliance 2 is functioning properly while appliance N does not detect any particular faults. However, appliance N is not functioning properly. Accordingly, a user may select the section 406 using a touchscreen interface element 407 and initiate a service request. The service request initiation may trigger the display of a user interface 500, as described below.

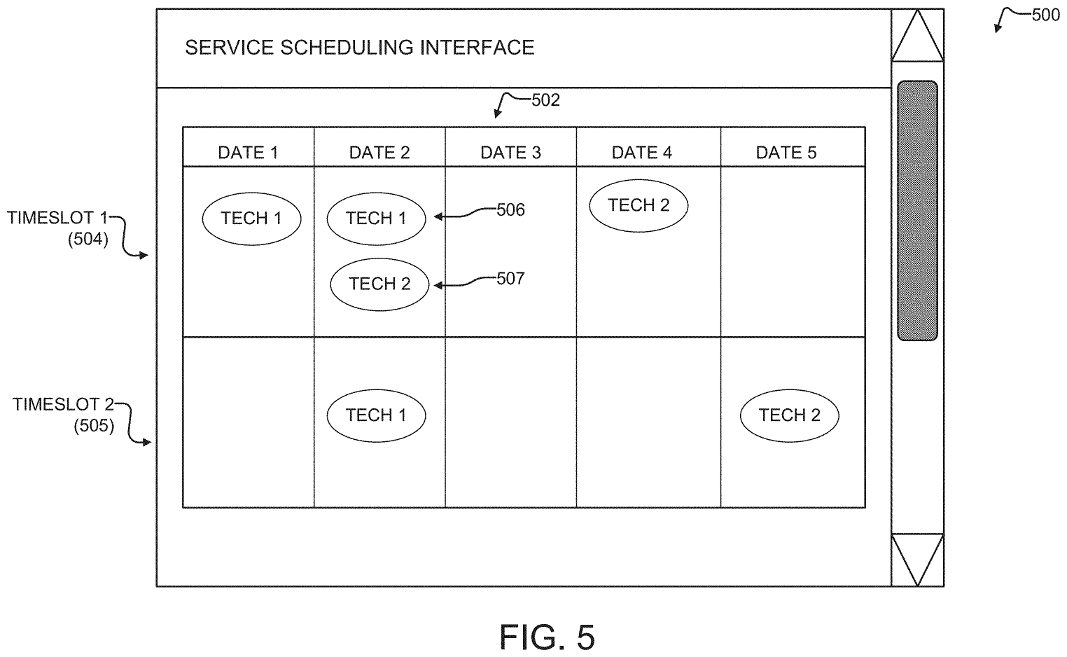

FIG. 5 is a diagram of a service scheduling user interface 500, according to example embodiments of the present disclosure. The user interface 500 facilitates the automatic scheduling of a service call to the location of the malfunctioning appliances 1 and N. As shown, a calendar or calendar-like interface section 502 is displayed to a user of the interactive assembly 110. The interface section 502 is arranged in a grid-like pattern such that a user may easily ascertain what times of day (e.g., 504, 505) and which technicians (e.g., 506, 507) are available to service the particular malfunctioning appliances 1 and N. In this example, upon selection of an associated interface element for a particular date, time, and technician, a second service scheduling interface 600 may be displayed.

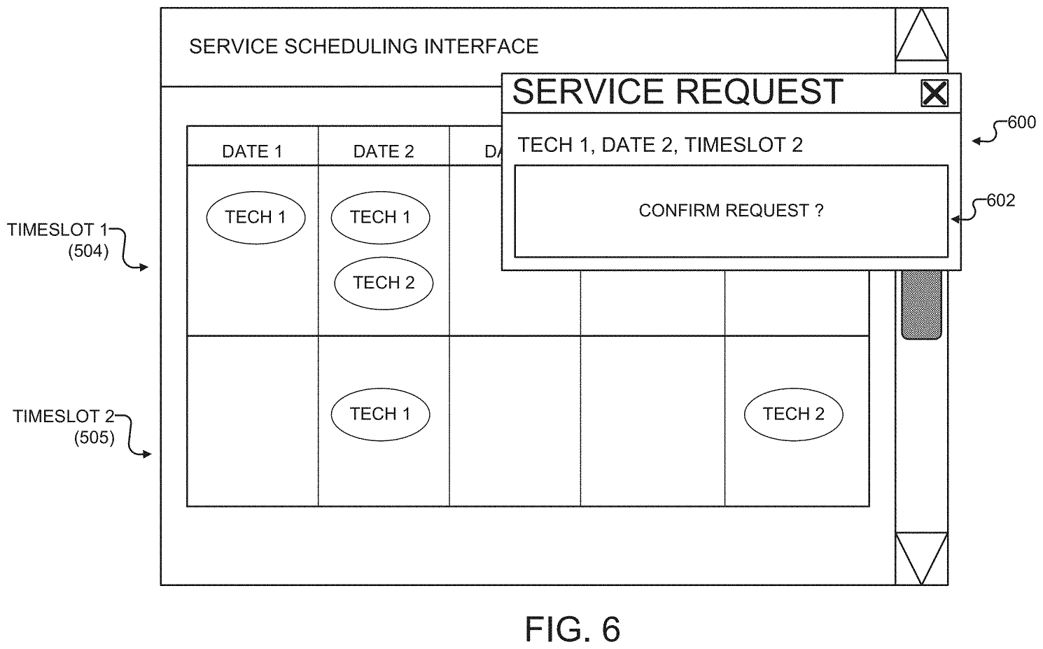

FIG. 6 is a diagram of the service scheduling user interface 600, according to example embodiments of the present disclosure. The user interface 600 may include a summary of the selected date, time or timeslot (e.g., timeslot 1 or timeslot 2), and technician for confirmation by the user using interface element 602. Upon confirmation, a service call will be automatically scheduled for the user. According to other embodiments, additional steps can be taken to ensure a smooth and engaging user interface upon confirmation. For example, a service interactive user interface 700 may also be displayed to a user upon confirmation through the user interface element 602.

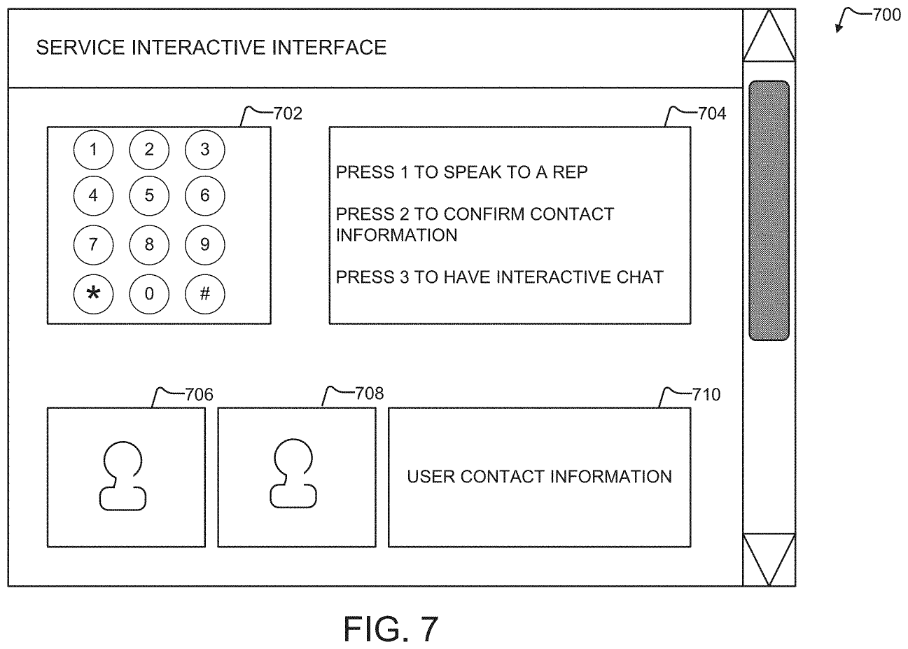

FIG. 7 is a diagram of the service interactive user interface 700, according to example embodiments of the present disclosure. As illustrated, the user interface 700 may include a selection interface 702 arranged as a 12-key friendly user interface. The user interface may also include an instruction section 704 to provide a user with a visual display of options available. This is particularly advantageous in that a user is not required to listen to, and remember each available option as per a typical telephone call to a service center.

Further, the user interface 700 also includes an interactive chat function having video feeds 706 and 708 for personal interaction with service technicians, call center employees, or other individuals. In this embodiment, a user may request to initiate interactive communication. In response to this request, communication may be initiated between the user and one or more of a call center employee and/or a technician. For example, the communication may be facilitated by requesting to initiate interactive communication from the user at the interactive assembly 110, and initiating an interactive video conference between the user and one of a technician and a call center representative, for example, through the data processing system 312. Finally, the user interface 700 may also include a user contact information section 710. The user contact information section 710 may allow a user to quickly verify all contact information, appliance data, and other suitable data prior to finalizing the scheduling of a service call.

As described above, various embodiments provide for the collection of diagnostic data from appliances in a user's home, the automatic display of availability of service technicians to service any malfunctioning appliances, and the confirmation of a service call. These features do not require a user to speak to a service representative directly and therefore benefit users with disabilities, hearing and/or speaking difficulty, and non-native English speakers. Hereinafter, methods of automating diagnostics and scheduling of service calls are described in detail.

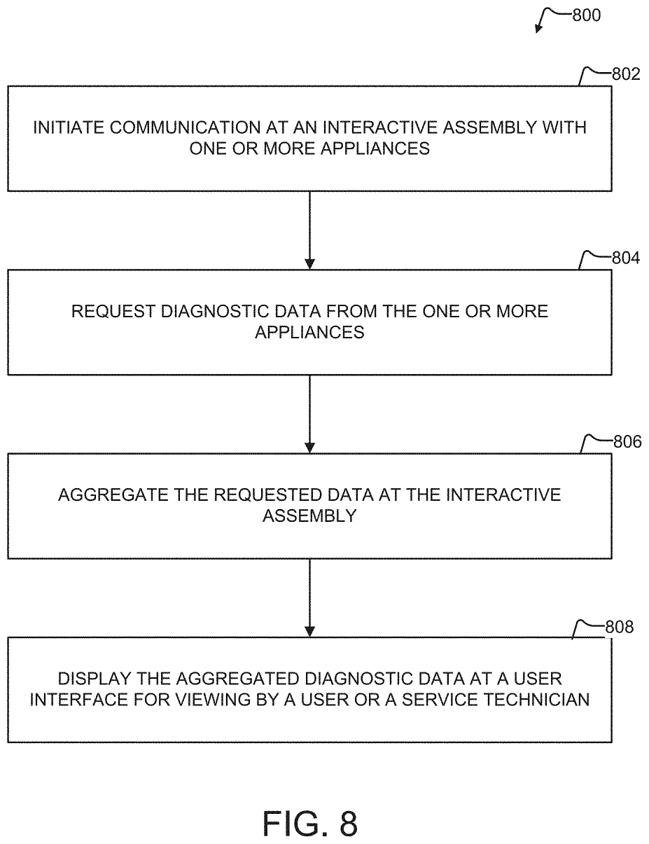

FIG. 8 is a flowchart of a method 800 of automating the diagnostics of appliances, according to example embodiments of the present disclosure. The method 800 may include initiating communication at an interactive assembly 110 with one or more appliances 304, 306, and 308, at block 802. For example, the interactive assembly 110 may be standalone or associated with a first appliance. The interactive assembly may also be in communication with a plurality of other appliances over the first network 302. The first network may facilitate the aggregation of this diagnostic data.

The method 800 further includes requesting diagnostic data from the one or more appliances 304, 306, and 308, at block 804. For example, the interactive assembly 110 may “ping” or directly request diagnostic data from each of the individual appliances. The request for diagnostic data may be automated or selected by a user. Automated diagnostic data requests may be performed periodically by the interactive assembly 110, may be initiated by an appliance periodically, or may be based upon any desired schedule. Furthermore, fixed dates for performing diagnostics based on a daily, weekly, monthly, or yearly schedule, or any variation thereof, may also be applicable.

The method 800 further includes aggregating the requested data at the interactive assembly 110, at block 806. For example, the interactive assembly may gather the received diagnostic data, and organize the received data based on each appliance it is associated with.

The method 800 also includes displaying the aggregated diagnostic data at a user interface for viewing by a user or a service technician, at block 808. For example, the interactive assembly 110 may display the organized data as shown in FIG. 4.

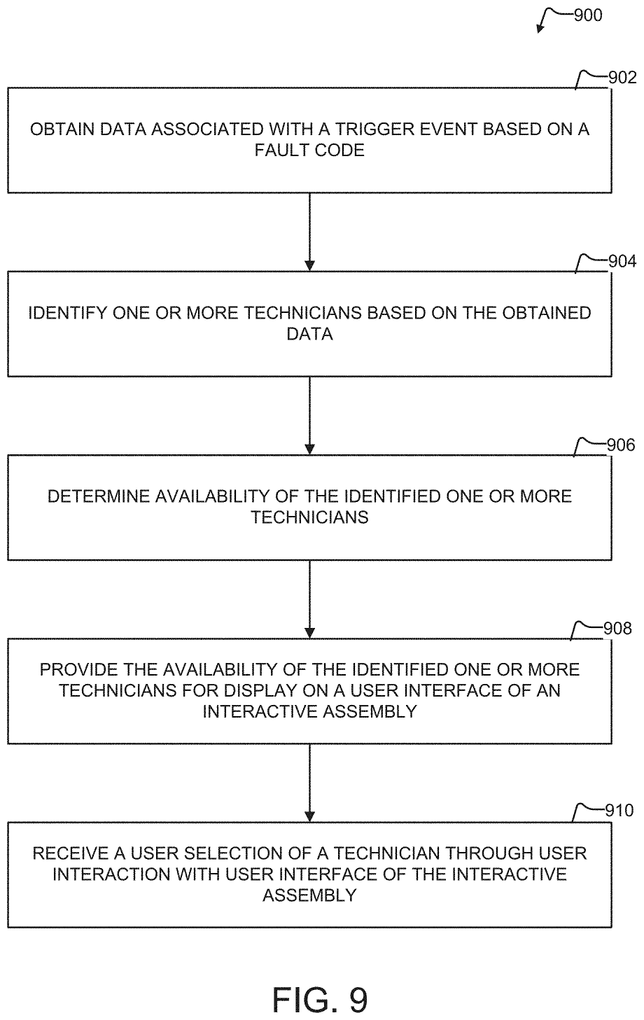

FIG. 9 is a flowchart of a method 900 of automating the scheduling of service calls of appliances, according to example embodiments of the present disclosure. The method 900 includes obtaining data associated with a trigger event based on a fault code of a malfunctioning appliance, at block 902. Obtaining the data may be facilitated by the first network 302. Furthermore, the fault code may be displayed to a user on the interactive assembly 110 as shown in FIG. 4. Additionally, the trigger event may include a user selecting an appropriate portion of the user interface 400 to trigger the communication between the interactive assembly 110 and the data processing system 312.

The method 900 further includes identifying one or more technicians based on the obtained data, at block 904. Generally, technicians may be identified based on a plurality of criteria, including availability, familiarity with a malfunctioning appliance, suitability of replacement parts carried by a particular technician, distance from a user or the location of the malfunctioning appliance, languages spoken by both the user and the technician, and other suitable criteria. Technicians may also be identified based on an ability to service malfunctioning appliances based on diagnostic data received. For example, a suitable technicians may be identified by an ability or availability of associated replacement parts available to be installed on an initial service visit.

The method 900 further includes determining the availability of the identified one or more technicians, at block 906. Determining availability may include receiving availability and/or scheduling information from the scheduling and service data store 314 associated with the call center. Additionally, according to at least one embodiment, availability may be provided directly from the remote device 320. In other examples, availability may be based on default scheduling on a central calendar managed at the data processing system 312. Still in other examples, availability may be facilitated by requesting scheduling availability of one or more technicians from a scheduling and service data store 314 associated with a call center.

The method 900 further includes providing the availability of the identified one or more technicians for display on a user interface of an interactive assembly 110, at block 908. For example, a calendar display such as that illustrated in FIG. 5 may be displayed at the interactive assembly 110.

The method 900 also includes receiving a user selection of a technician through interaction with a user interface of the interactive assembly 110, at block 910. The user selection can include a user interacting with the calendar display, depressing a particular section, and other similar events.

As described above, various methods and systems for automated diagnostics and scheduling of service calls associated with a malfunctioning appliance have been provided. The methods simplify the scheduling of service calls such that resources are minimized while transmittal of diagnostic data associated with an appliance is improved. Furthermore, the efficiency of a fleet of service technicians is improved such that increased fuel economy, reduced waste, and improved functionality of appliances is realized as compared to conventional service call scheduling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of automating diagnostics and scheduling of service calls associated with a malfunctioning appliance, comprising:
obtaining data associated with a trigger event based on a fault code of a malfunctioning appliance;
identifying one or more technicians based on the obtained data and a plurality of criteria including a familiarity of the one or more technicians with the malfunctioning appliance and a distance of the one or more technicians from a user of the malfunctioning appliance;
determining an availability of the one or more technicians;
providing the availability of the identified one or more technicians for display on a user interface of an interactive assembly in communication with the malfunctioning appliance; and
receiving a user selection of a technician through user interaction with the user interface on the interactive assembly.

2. The method of claim 1, further comprising:
receiving confirmation from the user of the user selection through the user interface on the interactive assembly.

3. The method of claim 1, wherein obtaining data associated with the trigger event comprises:
requesting, from the interactive assembly, diagnostic data from the malfunctioning appliance; and
transmitting the diagnostic data to a data processing system associated with a call center.

4. The method of claim 3, wherein identifying the one or more technicians comprises:
identifying one or more technicians capable of servicing the malfunctioning appliance based on the diagnostic data and an availability of necessary replacement parts.

5. The method of claim 1, wherein determining an availability of the one or more technicians comprises:
requesting scheduling availability of the one or more technicians from a scheduling and service data store associated with a call center.

6. The method of claim 1, wherein providing the availability of the identified one or more technicians for display on a user interface comprises:
displaying a scheduling user interface with a calendar display of the availability of the identified one or more technicians on the interactive assembly.

7. The method of claim 6, wherein receiving a user selection of the technician comprises:
receiving a user selection through the calendar display.

8. The method of claim 1, further comprising:
receiving a request to initiate interactive communication from a user at the interactive assembly; and
initiating an interactive video conference between the user and one of a technician and a call center representative.

9. The method of claim 1, wherein the interactive assembly is in communication with a plurality of appliances, and wherein the method further comprises:
requesting, from the interactive assembly, diagnostic data from the plurality of appliances; and
transmitting the diagnostic data for each of the plurality of appliances to a data processing system associated with a call center.

10. The method of claim 1, wherein the interactive assembly is associated with a first appliance, and wherein the interactive assembly is in communication with a plurality of appliances over a network.

11. A system for automating diagnostics and scheduling of service calls associated with a malfunctioning appliance, the system comprising:
an interactive assembly, comprising:
a casing;
an image monitor supported by the casing, the image monitor comprising a touchscreen display; and
a controller communicatively coupled with the image monitor, the controller configured to:
obtain data associated with a trigger event based on a fault code of a malfunctioning appliance;
identify one or more technicians based on the obtained data and a plurality of criteria including a familiarity of the one or more technicians with the malfunctioning appliance and a distance of the one or more technicians from a user of the malfunctioning appliance;
determine an availability of the one or more technicians;
provide the availability of the identified one or more technicians for display on a user interface of an interactive assembly in communication with the malfunctioning appliance; and
receive a user selection of a technician through user interaction with the user interface on the interactive assembly.

12. The system of claim 11, wherein the controller is further configured to:
receive confirmation from the user of the user selection through the user interface on the interactive assembly.

13. The system of claim 11, wherein obtaining data associated with the trigger event comprises:
requesting, from the interactive assembly, diagnostic data from the malfunctioning appliance; and
transmitting the diagnostic data to a data processing system associated with a call center.

14. The system of claim 13, wherein identifying the one or more technicians comprises:
identifying one or more technicians capable of servicing the malfunctioning appliance based on the diagnostic data and an availability of necessary replacement parts.

15. The system of claim 11, wherein determining an availability of the one or more technicians comprises:
requesting scheduling availability of the one or more technicians from a scheduling and service data store associated with a call center.

16. The system of claim 11, wherein providing the availability of the identified one or more technicians for display on a user interface comprises:
displaying a scheduling user interface with a calendar display of the availability of the identified one or more technicians on the interactive assembly.

17. The system of claim 16, wherein receiving a user selection of the technician comprises:
receiving a user selection through the calendar display.

18. The system of claim 11, wherein the controller is further configured to:
receive a request to initiate interactive communication from a user at the interactive assembly; and
initiate an interactive video conference between the user and one of a technician and a call center representative.

19. The system of claim 11, wherein the interactive assembly is in communication with a plurality of appliances, and wherein the controller is further configured to:
request, from the interactive assembly, diagnostic data from the plurality of appliances; and
transmit the diagnostic data for each of the plurality of appliances to a data processing system associated with a call center.

20. The system of claim 11, wherein the interactive assembly is associated with a first appliance, and wherein the interactive assembly is in communication with a plurality of different appliances over a network.
